(19) United States
(12) Patent Application Publication
(10) Pub. No.: US 2007/0198937 A1
(43) Pub. Date: Aug. 23, 2007

(54) Method for determining a profile of a user of a communication network

(76) Inventor: Sunny Paris, Paris (FR)

Correspondence Address: PAULEY PETERSEN & ERICKSON, 2800 WEST HIGGINS ROAD, SUITE 365, HOFFMAN ESTATES, IL, 60195, US

(21) Appl. No.: 10/592,347

(22) PCT Filed: Mar. 10, 2005
(86) PCT No.: PCT/IB05/00813

§ 371 Date: Sep. 11, 2006

(30) Foreign Application Priority Data
Mar. 10, 2004 (FR) 0402476

(51) Int. Cl. G06F 17/18

(52) U.S. Cl. 715/745; 702/181; 709/224

(57) ABSTRACT

The invention relates to a method and a system for determining a profile of a communications network user, the method includes:

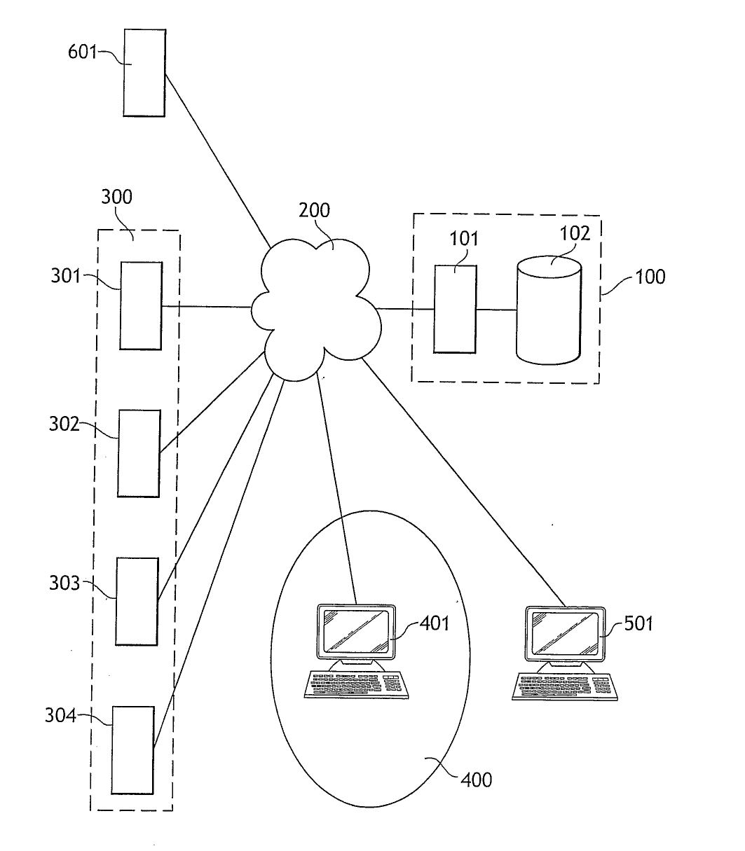

saving profile data regarding known network users in a database, these users forming a reference population, the profile data (Pᵢ) regarding known users including a set of attributes (j) values (Pᵢⱼ) associated to each user (i),

for each site or part of site (s) of a set of sites of interest accessible via the network, processing a set of probabilities (Pₛⱼ) that represent the attribute values of users that connect to the site or part of a site (s), according to the connection history of the users of the reference population to a site or a part of a site, and processing a probability that a user to be identified has a given attribute, according to the probabilities associated to the Internet sites or parts of a site (s) of interest to which the user connects during a specific time period.

The method is characterized in that the processing determines the probability (m₃ⱼ) that the user to be identified has a specific attribute (j) as a combination of a decorrelated probability value (m₁ⱼ) that takes into account the probabilities associated to the Internet sites or parts of a site (s) and a correlated probability value (m₂ⱼ) that takes into account average profile data (gⱼ) regarding the users that are part of the reference population.

### BACKGROUND OF THE INVENTION

1. Field of the Invention

The invention relates to the field of performing studies of the behavior of Internet users or any other communication network users.

2. Discussion of Related Art

Internet service providers, whether brokers, advertisers, e-commerce companies, publishers or more generally broadcasters of digital contents, would like to dynamically adapt the digital content they offer according to the profile of each Internet user in order to optimize efficiency. For example, they would like to be able to display advertising banners that are customized according to the profile of each Internet user that visits a site and to be able to highlight the various products according to the type of Internet user.

Document WO 02/33626 (published on Apr. 25, 2002) describes a method that allows determining the profile of a given unknown Internet user. This method includes using probability analysis to determine demographic attributes (marital status, age, gender, income, profession) of the Internet user mainly according to the URL address of the Internet pages he visits, the keywords he uses in his searches and the banners he selects. For this purpose, the method involves determining, from a reference population that includes Internet users with known socio-demographic profiles, sets of discriminating URL addresses for a set of attributes, including for example, gender, marital status, or profession. These sets of URL addresses allow obtaining for each unknown Internet user a score associated to each attribute, this score being computed according to the URL address the Internet user has visited.

This profiling method gives results in terms of the most common Internet populations, that is, the populations that present the most widespread attributes. On the other hand, this method is not well suited for determining the profiles of minority Internet users.

Furthermore, the method proposed in document WO 02/33626 is based on URL addresses and does not allow determining reliable conclusions as regards to the socio-demographic profile of an Internet user.

### SUMMARY OF THE INVENTION

An objective of the invention is to provide a profiling method that leads to more accurate results than the methods of the prior art.

For this purpose, the invention proposes a method for determining a profile of a user to be identified of a communications network, the method comprising:

saving profile data regarding known network users in a database, these users being part of a reference population, the profile data regarding known users including a set of attributes values associated to each user,

for each site or part of a site of a set of sites of interest accessible via the network, processing a set of probabilities that represent the attribute values of the users that connect to the site or part of site, according to connection history of the users of the reference population to the site or the part of site, and

processing a probability that the user to be identified has a given attribute, according to the probabilities associated to the sites or parts of sites of interest to which the user connected during a given time period,

wherein the processing determines the probability that the user to be identified has a given attribute as a combination of a decorrelated probability value that takes into account the probabilities associated to the sites or parts of sites of interest and a correlated probability value that takes into account average profile data regarding the users that are part of the reference population.

The expression “part of a site” refers to a page or group of pages that belong to the same site and that constitute a themed entity for applying the method.

The calculation of the decorrelated probability depends solely on the set of sites or parts of a site that the user to be identified has visited and therefore the probabilities associated to each attribute for the sites or parts of a site visited.

The calculation of the correlated probability also takes into account the average profile of the members of the reference population; that is, for each attribute, the average of probabilities associated to this attribute for all the members of the reference population.

Such a method has the advantage of combining a decorrelated approach that favors the prediction of majority features from a reference population and a correlated approach that favors the prediction of minority features from among the members of the reference population. This method leads to more relevant results than those provided by the techniques of the prior art.

The combination of the two types of probabilities can be performed according to a combination rule established in an empirical manner according to the behavior of the reference population (it is assumed that the reference population is representative of the overall population of network users).

In an embodiment of the invention, the combination of decorrelated and correlated probability values is a linear combination.

The combination of the decorrelated and correlated probability values depends on combination parameters that can be empirically determined according to the reference population.

In particular, these parameters are determined by applying the probability calculation to the members of the reference population, to define a mixing rate to be applied between the correlated approach and the decorrelated approach.

In an embodiment of the invention, when an Internet user to be identified connects using the network to a server hosting a site, the server hosting the site transmits an identification request of the user to the profiling server and the profiling server returns data relative to the profile of the user to the server that hosts the site.

Thus, the server that hosts the site adapts the presentation of the site according to the data relative to the profile of the user.

The invention also refers a system for determining a profile of a user to be identified of a communication network, comprising a profiling server connected to the network and which includes a processor, wherein the processing means are adapted for determining a probability that a user to be identified has a given attribute, depending on the probabilities associated to said sites of interest to which the user has been connected during a given period of time.

In this system, the processor determines the probability that the user has a specific attribute as a combination of a decorrelated probability value that takes into account the probabilities associated to the sites of interest and a correlated probability value that takes into account average profile data relative to users that are part of a reference population.

For this purpose, in an embodiment of this system, the server is adapted to be connected to a database that contains profile data relative to known users of the network, these users being part of the reference population, the profile data relative to the known users including a set of attributes values associated to each user.

Furthermore, the processor is adapted for determining, for each site of a set of sites of interest accessible via the network, a set of probabilities that represent the attributes values of the users that connect to the site, according to the connection history of the users of the reference population to the site.

Other features and advantages will be indicated in the description that follows, which is provided solely for illustrative and non-limiting purposes and must be read while referring to the only attached FIGURE.

### BRIEF DESCRIPTION OF THE DRAWING

The FIGURE is a diagram that represents a profiling system according to the invention.

### DETAILED DESCRIPTION OF THE INVENTION

On the FIGURE, the profiling system 100 is connected to a communication network 200 (such as the Internet) to which a set 300 of Web servers of interest 301 to 304 are connected. Each Web server hosts a site or digital content made available to the network 200 users (Internet users) by a service provider.

To adapt the services they offer, service providers would like to know in real time the profile of the Internet users that visit their sites.

The profiling system 100 includes a profiling server 101, which includes a processor adapted for calculating the profile data regarding the Internet users that connect to the Web servers of interest 301 to 304.

The profiling server 101 is connected to a database 102 that contains the data regarding the members of a reference population 400 of Internet users.

The profiling server 101 is lined to a database 102 that contains the data relative to the members of a reference population 400 of Internet users.

The reference Internet users population 400 groups voluntary Internet users that agree to provide profile data about themselves. These Internet users are recruited, for example, by telephone or directly on-line over the Internet, depending on the socio-demographic criteria considered as representative of an overall population (for example, the population of Internet users in a country), or randomly. Sensor software and/or a cookie is/are installed on the computer 401 or the navigation station of each member of the Internet user reference population. The recruited members can be subjected to a selection process or processing operation in order to create a population that can be considered representative.

The cookie contains data that identifies the Internet user.

The purpose of the sensor software is to record the navigation of the Internet user; that is, the various sites or parts of sites that he visited over time. The sensor software regularly transmits information regarding the navigation history of the members of the reference population to the profiling server via the network 200. The profiling server 101 records information it receives from the software into the database 102. Information collection can also be performed using markers placed on the pages of the sites of interest as described below.

Depending on the different Web sites visited by the members of the reference population, the profiling server 101 is adapted for statistically determining the profile of Internet users that connect to a specific site of interest 301 to 304.

The profile of an Internet user is composed of a series of attribute values associated to this Internet user. Attributes are data elements associated to each Internet user that are of interest to service providers. These attributes relate to, for example, the gender, age, and socio-professional category of the Internet user. Other types of attributes can be of interest to service providers and can be included in the profile, such as the income level of the Internet user, his/her geographical location, areas of interest, type of computer he/she uses (home computer or work, type of navigator, screen resolution, connection speed).

The profiling server 101 determines profile Pᵢ of a given Internet user i as a sequence that includes N attribute values pᵢⱼ, pᵢⱼ being the probability that Internet user i has attribute j.

The profile of an Internet user i is given:
Pᵢ=(pᵢ₁,pᵢ₂,pᵢ₃,pᵢ₄,pᵢ₅,pᵢ₆,pᵢ₇,pᵢ₈,pᵢ₉,pᵢ₁₀, pᵢ₁₁,pᵢ₁₂,pᵢ₁₃, . . . p_{iN}) [1]
where, in particular, pᵢ₁ is the probability of Internet user i being a woman (j=1),
pᵢ₂ is the probability of Internet user i being a man (j=2),
pᵢ₃, pᵢ₄, pᵢ₅, pᵢ₆, pᵢ₇, pᵢ₈ are the probabilities that Internet user i is, respectively, 0 to 14 years old (j=3), 15 to 24 years old (j=4), 25 to 34 years old (j=5), 35 to 49 years old (j=6), 50 to 64 years old (j=7), more than 65 years old (j=8),
pᵢ₉, pᵢ₉, pᵢ₁₀, pᵢ₁₁, pᵢ₁₂, pᵢ₁₃ are the probabilities that Internet user i belongs to certain types of socio-professional categories (j=9, 10, 11, 12, or 13),
   other attributes 14 to N are also taken into account.

Furthermore, the attribute values pᵢⱼ of profile Pᵢ must meet the following conditions:
pᵢ₁+pᵢ₂ [2]
pᵢ₃+pᵢ₄+pᵢ₅+pᵢ₆+pᵢ₇+pᵢ₈=1 [3]
pᵢ₉+pᵢ₁₀+pᵢ₁₁+pᵢ₁₂+pᵢ₁₃=1 [4]

The profiling server 101 also determines profile Pₛ of a given Web site of interest as a sequence that also includes N attribute values pₛⱼ, pₛⱼ being the probability that an Internet user that visits the site s has attribute j.

The profile of a site is given:
Pₛ=(pₛ₁,pₛ₂,pₛ₃,pₛ₄,pₛ₅,pₛ₆,pₛ₇,pₛ₈,pₛ₉,pₛ₁₀,pₛ₁₁,pₛ₁₂,pₛ₁₃, . . . p_{sN}) [5]
where attribute values pₛⱼ of profile Pₛ are determined according to the attribute values of the Internet users of the reference population that visits site s.

For a given site of interest s, the value Pₛⱼ, of attribute j is the average of values pᵢⱼ associated to the Internet users of the reference population that visit the site s. Thus, if among the Internet users of the reference population 400 that visit site s, 40% are women and 60% are men, then we would have pₛ₁=0.4 and pₛ₂=0.6.

When an Internet user 501, which can be a known Internet user (that is; he/she belongs to the reference population 400) or an unknown Internet user (that is, he/she does not belong to the reference population 400) connects to a site s, the Web server 601 that hosts the site transmits an Internet user identification request to the profiling server 101. The profiling server 101 determines and returns data containing the profile of said Internet user to the Web server 601. This profile is determined according to the connection history of Internet user 501 on the Web servers of interest 301 to 304 by comparing this history with the history of the members of the reference population 400.

To obtain the history of an Internet user 501, the Web servers 301 to 304 host sites in which some pages are marked by page markers. These markers reside on the profiling server 101 so that when Internet user 501 accesses a Web page thus marked, the downloading of the marker triggers the transmission of a request to the profiling server 101. This request indicates to the profiling server 101 that the Internet user has loaded a specific Web page.

When Internet user 501 successively connects to a series of Web sites, he/she triggers the successive transmission of requests to the profiling server 101. These requests are interpreted by the profiling server as navigation data. This data is recorded by the profiling server 101 into a database 102 and constitutes the navigation history of the Internet user to be identified.

From this history, the profiling server 101 can determine a statistical profile of the Internet user to be identified 501 by comparing it with the data related to Internet users of the reference population 400.

For this purpose, the profiling server 101 determines a first statistical profile M₁ of the Internet user 501 according to an initial calculation method called “decorrelated”. This method depends solely on the set of sites s that Internet user 501 has visited and therefore on the probabilities associated to each attribute for the visited sites.

$$\begin{matrix}{M}_{1} = ( {m}_{1 , 1} , {m}_{1 , 2} , {m}_{1 , 3} , {m}_{1 , 4} , {m}_{1 , 5} , {m}_{1 , 6} , {m}_{1 , 7} , {m}_{1 , 8} , {m}_{1 , 9} , {m}_{1 , 10} , {m}_{1 , 11} , {m}_{1 , 12} , {m}_{1 , 13} , … , {m}_{1 , N} ) & [ 6 ] \\ with {m}_{1 , j} = {\prod }_{s = 1}^{x} {( {p}_{sj} )}^{ln ( e + {n}_{s} - 1 )} & [ 7 ]\end{matrix}$$

where nₛ is the number of times the Internet user has visited site s during a specific period of time (for example in the last two months), e is the Euler number, x is the number of sites visited by the Internet user 501.

The profiling server 101 also determines a second statistical profile M₂ of the Internet user 501, according to a second calculation method called “correlated”.

This method takes into account the average profile G of the Internet users in the reference population 400; that is, for each attribute j, the average of probabilities pᵢⱼ associated to this attribute for all the members of the reference population. The average profile G is determined as follows:
G=(g₁,g₂,g₃,g₄,g₅,g₆,g₇,g₈,g₉,g₁₀,g₁₁,g₁₂,g₁₃, . . . g_{N}) [8]
where for each attribute j, gⱼ is the average of the values of attribute j for all the members of the reference population 400.

The second statistical profile is defined by:

$$\begin{matrix}{M}_{2} = ( {m}_{2 , 1} , {m}_{2 , 2} , {m}_{2 , 3} , {m}_{2 , 4} , {m}_{2 , 5} , {m}_{2 , 6} , {m}_{2 , 7} , {m}_{2 , 8} , {m}_{2 , 9} , {m}_{2 , 10} , {m}_{2 , 11} , {m}_{2 , 12} , {m}_{2 , 13} , … , {m}_{2 , N} ) & [ 9 ] \\ with {m}_{2 , j} = {\prod }_{s = 1}^{x} {( \frac{{p}_{sj}}{{g}_{j}} )}^{ln ( e + {n}_{s} - 1 )} & [ 10 ]\end{matrix}$$

where nₛ is the number of times the Internet user 501 has visited site s during a specific period of time (for example, in the last two months), e is the Euler number, x is the number of sites visited by the Internet user.

It can be noted that in the two calculation methods above (equations [7] and [10],) the power function ln(e+nₛ−1) takes into account the parameter nₛ that corresponds to the number of times the Internet user 501 has visited site s during a specific period of time. According to these calculation methods, the greater the number of visits to the same site, the greater the importance of the attributes associated to this site in determining the profile of the Internet user 501. Nevertheless, it is also possible to consider that the determining criterion is not the number of visits the Internet user makes to a same site, but rather it is the diversity of the sites visited by the Internet user. In this case, the function ln(e+nₛ−1) can be replaced in equations [7] and [10] by a different function ƒ(nₛ), in particular a slow increase function or a constant function, equal to 1.

The first calculation method called “decorrelated” favors the prediction of attribute values that conform to those that are associated to the majority members of the reference population 400, while the second calculation method called “correlated” favors the prediction of attribute values that conform to those that are associated to the minority members of the reference population 400.

For example, suppose that, on the one hand and based on the reference population 400 (which is meant to be representative of the overall Internet user population), it is observed that the connections to sites are made 30% by women and 70% by men. On the other hand, consider specific Internet users 501 that essentially visit sites 301 to 304, where the profile is 60% men and 40% women. These Internet users 501 will be considered mostly as male by the first calculation method because they visit the sites that have a tendency to be visited by men. On the other hand, these same Internet users will be considered female by the second calculation method, because they visit sites with a greater tendency than other sites to be visited by women.

In order to make the most of the “correlated” and “decorrelated” calculations methods for obtaining results that are close to reality, the profiling server 101 calculates a combined statistical profile M₃ of Internet user 501 obtained, like the combination of the M₁ profile, according to the decorrelated probability calculation and the M₂ profile obtained according to the correlated probability calculation.
M₃=(m_{3,1},m_{3,2},m_{3,3},m_{3,4},m_{3,5},m_{3,6},m_{3,7},m_{3,8},m_{3,9},m_{3,10},m_{3,11},m_{3,12},m_{3,13}, . . . ,m_{3,N}) [11]
with m_{3,j}=αⱼm_{1,j}+(1−αⱼ)m_{2,j} for jε[1,N] [12]
where αⱼ is the combination parameter of the decorrelated probability value m_{1,j} and of the correlated probability value m_{2,j} determined for attribute j, αⱼ being comprised between 0 and 1.

The linear combination parameters αⱼ can be determined in an empirical manner by applying the probability calculation to the members of the reference population 400 in order to determine the combination rate to be applied between the correlated approach and the decorrelated approach. These combination parameters are updated on a regular basis to take into account changes in the reference population.

To perform a direct calculation, the profiling server 101 can determine a new average profile G₃ in the following manner:

$$\begin{matrix}{G}_{3} = ( {g}_{3 , 1} , {g}_{3 , 2} , {g}_{3 , 3} , {g}_{3 , 4} , {g}_{3 , 5} , {g}_{3 , 6} , {g}_{3 , 7} , {g}_{3 , 8} , {g}_{3 , 9} , {g}_{3 , 10} , {g}_{3 , 11} , {g}_{3 , 12} , {g}_{3 , 13} , … {g}_{3 , N} ) & [ 13 ] \\ with {g}_{3 , j} = \frac{1}{{α}_{j} + \frac{1 - {α}_{j}}{{g}_{j}}} & [ 14 ]\end{matrix}$$

So that the mixed statistical profile M₃ can be calculated directly by the profiling server in the following manner:

$$\begin{matrix}{m}_{3 , j} = {\prod }_{s = 1}^{x} {( \frac{{p}_{s , j}}{{g}_{3 , j}} )}^{ln ( e + {n}_{s} - 1 )} & [ 15 ] \\ {m}_{3 , j} = {\prod }_{s = 1}^{x} {( {α}_{j} \cdot {p}_{s , j} + ( 1 - {α}_{j} ) \cdot \frac{{p}_{s , j}}{{g}_{j}} )}^{ln ( e + {n}_{s} - 1 )} & [ 16 ]\end{matrix}$$

An example of a sequence of combination parameters that can be used is as follows:
A=(α₁,α₂,α₃,α₄,α₅,α₆,α₇,α₈,α₉,α₁₀,α₁₁,α₁₂, . . . α_{N})
A=(0.30,0.30,0.65,0.65,0.65,0.65,0.65,0.65,0.65,0.40,0.40,0.40,0.76 0.76 . . . α_{N}) [17]

According to an optional stage, the profiling server 101 can convert the probability profile M₃ of the Internet user 501 into a “determined” profile I. This conversion stage into a determined profile involves converting probabilities m_{3,j} into a determined profile D of the Internet user 501 that includes specific attributes, in the following manner:
D=(d_{i,1},d_{i,2},d_{i,3},d_{i,4},d_{i,5},d_{i,6},d_{i,7},d_{i,8},d_{i,9},d_{i,10},d_{i,11},d_{i,12},d_{i,13}, . . . d_{i,N}) [18]
in which d_{i,j} is equal to 0 or 1, while respecting conditions [2], [3], and [4]. The determined profile D indicates whether the Internet user to be identified 501 is a man or woman, the age range in which he/she belongs and his/her socio-professional category, as well as other attributes.

This conversion necessarily leads to prediction errors that depend on the size of the navigation history of Internet user i. Indeed, the more an Internet user visits a large number of sites, the more refined the prediction. Consequently, whether the conversion into a determined profile will be performed or not depends on whether the error generated by this conversion is less than or not less than an acceptable prediction error for each attribute.

The acceptable prediction error is fixed in collaboration with the service providers of each of the sites to which the profiling results are to be sent.

The following can be noted:

N, the number of sites or parts of a site visited by an Internet user i and recorded by the profiling server 101 during a predetermined period of time (for example the last two months),

eⱼ, the error generated (in a percentages) when the profiling server 101 predicts that an Internet user has attribute j,

êⱼ, the maximum acceptable error (in a percentage) when the profiling server 101 predicts that an Internet user has attribute j,

\hat{p}ⱼ, the minimum probability threshold associated to attribute j necessary to predict that the Internet user presents attribute j so that the prediction error eⱼ is less than êⱼ, this minimum probability threshold depends on the number of sites or parts of a site N visited by an Internet user.

Based on the known Internet users of the reference population 400 that have performed a given number of visits N, the profiling server 101 determines, for each attribute j, the probability threshold \hat{p}ⱼ below which the prediction error eⱼ is less than êⱼ. It performs this calculation for each N value.

For an Internet user i having performed a number N of visits, a determined profile D is calculated as follows:
For each attribute j, if m₃ⱼ≧\hat{P}ⱼ then dᵢⱼ=1[19]

This means that when the attribute value m₃ⱼ is below a specific threshold, the Internet user i is considered as presenting attribute j. The profiling server 101 records the profile D thus determined into the database 102.

Furthermore, in a preferred embodiment of the invention, the determined profile D is calculated by the profiling server by taking into account each attribute j of a set of predefined attributes according to a predetermined priority order Z. The profiling server 101 verifies the conditions m₃ⱼ≧\hat{p}ⱼ (equation [19]) for each attribute j in the priority order Z of attributes j. This predetermined order is chosen according to the commercial importance of each attribute for a specific service provider.

The order Z can be as follows, for example:
Z=(j=2,j=1,j=8,j=5,j=4,j=6,j=7,j=3 . . . )
so that the verified conditions are based on attributes according to which the Internet user is a man (j=2), a woman (j=1), the Internet user is more than 65 old (j=8), is between 25 and 34 years old (j=5), is between 15 and 25 years old (j=4), is between 35 and 49 years old (j=6), is between 50 and 64 years old (j=7), and between 0 and 14 years old (j=3), in this order.

The order Z can be modified over time and according to the service providers to which the profiling results are to be sent. The result is that the proposed profiling method can be adapted according to the profile type that each service provider wants to highlight as a priority.

When the Internet user 501 connects to a site, the Web server 601 that hosts the site transmits an Internet user 501 identification request to the profiling server 101. The profiling server 101 provides, in return and in real time, data regarding the profile of the Internet user. In particular, it forwards the profile D of Internet user 501 in question. The Web server 101 can then adapt the presentation of the site: graphics, navigation method or advertising spaces according to the data relative to the socio-demographic profile of the Internet user. The Web server 101 can keep the data relative to the profile of the Internet server in memory or store it in a cookie that it installs in the Internet user's navigator. Thus, the profile of the Internet user 501 will be immediately available to the Web server 501 for the subsequent visits made by the Internet user over a specific period of time (for example, for a period of three weeks.)

The data contained in the database 102 relative to the reference population 400 is updated regularly as the population evolves. The data relative to the various sites are also updated according to the members of the reference population.

The profiling server 101 is also adapted to generate a record on the connections to a site of particular interest. This record can be accessed online by the site's service provider using the server 101. The record indicates, for example, the number of Internet users that have visited the site over a specific period of time and presents the profile of these Internet users in a statistical manner. The record can also include the prediction error rate associated to the presented profile data.

In an alternative embodiment, the profiling system 100 and the Web server 601 are not located on the same Internet domain. In this case, the Web server 601 does not have access to the Internet user 501 profile. In this alternative embodiment, the server 601 requests the Internet user's 501 navigator to send an identification request to the profiling server 101. This way, it is the Internet user's 501 navigator that transmits an identification request to the profiling server 101, and not the server 601.

Such a request can be performed in a blocking manner; the Internet user 501 does not access the site until the server 601 has obtained the data containing his/her profile. In this case, the server 601 forwards the Internet user to be identified 501 to the profiling server 101. The profiling server 101 determines the data relative to the Internet user 501 profile, and for this purpose it determines a profile D for this Internet user, or extracts this profile from the database 102. Then, the profiling server 101 forwards the Internet user 501 to the URL address of the initially requested server 601. This time, the Internet user request is enriched with data relative to the profile of the Internet user. As an alternative, this request can be performed in a non-blocking manner; for example, through an invisible image.

Furthermore, the profiling server 101 records into the database 102 a data element that indicates that it has sent the profile D of a specific Internet user to the server 601. If it turns out that this Internet user is part of the reference population 400, then the profiling server 101 verifies the quality of the profile D that it has determined; that is, it compares the profile D that it has determined with the declared profile of the Internet user. If there is a difference between the profile D and the declared profile, the profiling server 101 can send the declared profile of the Internet user to the server of interest 301.

1. A method for determining a profile of a user to be identified (501) of a communications network (200), the method comprising:
saving profile data regarding known network users in a database (102), these users being part of a reference population (400), the profile data (Pᵢ) regarding known users including a set of attributes (j) values (pᵢⱼ) associated to each user (i),
for each site or part of a site (s) of a set of sites of interest (300) accessible via the network (200), processing, a set of probabilities (pₛⱼ) that represent the attribute values of the users that connect to the site or part of site (s), according to connection history of the users of the reference population (400) to the site or the part of site, and
processing, a probability that the user to be identified (501) has a given attribute, according to the probabilities associated to the sites or parts of sites of interest (s) to which the user connected during a given time period,
wherein the processing determines the probability (m₃ⱼ) that the user to be identified (501) has a given attribute (j) as a combination of a decorrelated probability value (m₁ⱼ) that takes into account the probabilities associated to the sites or parts of sites of interest (s) and a correlated probability value (m₂ⱼ) that takes into account average profile data (gⱼ) regarding the users that are part of the reference population (400).

2. The method according to claim 1, wherein the combination of decorrelated probability values (m₁ⱼ) and correlated probability values (m₂ⱼ) is a linear combination.

3. The method according to claim 1, wherein the combination of the decorrelated probability value (m₁ⱼ) and correlated probability value (m₂ⱼ) depends on combination parameters that are empirically determined according to the profile data relative to the known users of the reference population (400).

4. The method according to claim 3, wherein the combination parameters are regularly updated in order to take into account an evolution of the reference population.

5. The method according to claim 1, wherein the processing means determine a decorrelated probability m₁ⱼ that a user to be identified (501) has a given attributed j, according to the relation
$${m}_{1 , j} = {\prod }_{s = 1}^{x} {( {p}_{sj} )}^{( {fn}_{s} )}$$
where ƒ(nₛ) is a power function that depends on the number of times nₛ that the user to be identified (501) has visited the site of interest s during the given period of time, e is the Euler number and x is the number of sites visited by the user (501).

6. The method according to claim 1, wherein the processing means determine a correlated probability m_{2,j} that the user to be identified (501) has a given attribute j according to the relation
$${m}_{2 , j} = {\prod }_{s = 1}^{x} {( \frac{{p}_{sj}}{{g}_{j}} )}^{f ( {n}_{s} )}$$
where ƒ(nₛ) is a power function that depends on the number of times nₛ that the user to be identified (501) has visited the site of interest s during the given period of time, e is the Euler number, x is the number of sites visited by the user, and gⱼ is an average value of attribute j for all the known users of the reference population (400).

7. The method according to claim 5, wherein the power function ƒ(nₛ) is equal to ln(e+nₛ−1).

8. The method according to claim 1, wherein the processing determines the probability m_{3,j} that the user to be identified (501) has a specific given attribute j according to the relation:
m_{3,j}=αⱼm_{1,j}+(1−αⱼ)m_{2,j}
where αⱼ is the combination parameter of the decorrelated probability value m_{1,j} and of the correlated probability value m_{2,j} determined for attribute j.

9. The method according to claim 1, further comprising converting probabilities (m₃ⱼ) that the user to be identified (501) has one or several given attributes (j) into a determined profile (D) of the user (501) including given attributes.

10. The method according to claim 9, wherein performing the converting is dependent on whether the error generated by the converting (eⱼ) is less than or not less than an acceptable prediction error (êⱼ) for each attribute (j).

11. The method according to claim 10, wherein when the probability (m₃ⱼ) that the user to be identified (501) has a given attribute (i) is greater than a specific threshold (\hat{p}ⱼ) that depends on the acceptable prediction error (êⱼ) for this attribute, the user to be identified (501) is considered as having the attribute (j).

12. The method according to claim 9, wherein the determined profile (D) is calculated by the processing means taking into account each attribute (i) of a predefined set of attributes according to a predetermined priority (Z), this priority order (Z) being chosen according to the commercial importance of each attribute (j) for a given service provider.

13. The method according to claim 1, wherein the processing determines the probability that a user to be identified (501) has a given attribute (j), this attribute being relative to the gender, age, socio-professional category, income level, geographical location, interest areas or computer type of the user.

14. The method according to claim 1, wherein the sites of interest include pages, some of which being marked with page markers, and wherein downloading of the marker triggering transmission of a request to the processor, this request indicating that a given user downloads a specific page.

15. The method according to claim 1, wherein when the user to be identified (501) connects, via the network (200), to a server (601) that hosts a site (s), the server (601) that hosts the site transmits an identification request of the user to be identified (501) to a profiling server (101) that includes a processor, and the profiling server (101) returns the data relative to the profile of the user to be identified (501) to the server (601) that hosts the site (s).

16. The method according to claim 1, wherein when the user to be identified (501) connects, via the network (200), to a server (601) that hosts a site (s), the server (601) that hosts the site forwards the user to be identified (501) to a profiling server (101) that includes a processor, the profiling server (101) determines the data relative to the profile of the user and resends the user to the server (601) that hosts the site (s), with data relative to the profile of the user to be identified (501).

17. The method according to claim 15, wherein the server (601) that hosts the site (s) adapts the presentation of the site according to the data relative to the profile of the user to be identified (501).

18. The method according to claim 15, wherein the server (601) that hosts the site (s) keeps the data relative to the profile of the user that was returned by the profiling server (101) in memory or stores this data in a cookie that it installs in the navigator of the user to be identified (501).

19. The method according to claim 1, wherein a profiling server (101) generates a report regarding the connections made to a site (s) hosted by a server (601), the report indicating the number of users that have visited the site over a specific period of time and presenting the profile data regarding these users.

20. The method according to claim 19, wherein the report generated by the profiling server (101) includes a prediction error rate associated to the presented profile data.

21. A system (100) for determining a profile of a user to be identified (501) of a communication network (200), comprising a profiling server (101) connected to the network (200) and which includes a processor, wherein the processor is adapted for determining a probability that a user to be identified (501) has a given attribute, depending on the probabilities associated to said sites of interest to which the user has been connected during a given period of time,
wherein the processor determines the probability (m₃ⱼ) that the user has a specific attribute (j) as a combination of a decorrelated probability value (m₁ⱼ) that takes into account the probabilities associated to the sites of interest and a correlated probability value (m₂ⱼ) that takes into account average profile data (gⱼ) relative to users that are part of a reference population (400).

22. The system (100) according to claim 21, wherein the server is adapted to be connected to a database (102) that contains profile data (Pᵢ) relative to known users of the network, these users being part of the reference population (400), the profile data (Pᵢ) relative to the known users including a set of attributes (j) values (pᵢⱼ) associated to each user (i).

23. The system according to claim 21, wherein the processor is adapted for determining, for each site (s) of a set of sites of interest accessible via the network (200), a set (Pₛ) of probabilities (pₛⱼ) that represent the attributes values of the users that connect to the site (s), according to the connection history of the users of the reference population (400) to the site (s).

24. The method according to claim 6, wherein the power function ƒ(nₛ) is equal to ln(e+nₛ−1).

25. The method according to claim 11, wherein the determined profile (D) is calculated by the processing means taking into account each attribute (j) of a predefined set of attributes according to a predetermined priority (Z), this priority order (Z) being chosen according to the commercial importance of each attribute (j) for a given service provider.

26. The method according to claim 16, wherein the server (601) that hosts the site (s) adapts the presentation of the site according to the data relative to the profile of the user to be identified (501).

27. The method according to claim 16, wherein the server (601) that hosts the site (s) keeps the data relative to the profile of the user that was returned by the profiling server (101) in memory or stores this data in a cookie that it installs in the navigator of the user to be identified (501).

28. The system according to claim 22, wherein the processor is adapted for determining, for each site (s) of a set of sites of interest accessible via the network (200), a set (Pₛ) of probabilities (pₛⱼ) that represent the attributes values of the users that connect to the site (s), according to the connection history of the users of the reference population (400) to the site (s).
